(19) United States
(12) Patent Application Publication
(10) Pub. No.: US 2023/0409985 A1
(43) Pub. Date: Dec. 21, 2023

(54) Systems and Methods for Booking Resources

(71) Applicant: Golf Surprize PTY LTD, Salamander Bay NSW (AU)

(72) Inventor: Anthony Robinson, Salamander Bay NSW (AU)

(21) Appl. No.: 18/301,329

(22) Filed: Apr. 17, 2023

(30) Foreign Application Priority Data
May 23, 2022 (AU) 2022901372

(51) Int. Cl. G06Q 10/02; G06Q 30/0208; G06Q 20/10; G06Q 20/38

(52) U.S. Cl. CPC G06Q 10/02; G06Q 30/0208; G06Q 2220/00; G06Q 20/38215; G06Q 20/10

(57) ABSTRACT

Embodiments relate to a system for booking a resource, the system being configured to receive resource data, resource record data, and offer data. The system associates an offer with a resource and a resource record to generate a booking offering, which is transmitted to a user. The system presents the resource, the resource record, the offer, and the booking offering to the user at a user-device. The system receives a selection, by the user on the user-device, of the booking offering. The system then facilitates a transfer of electronic funds from a user to a commercial partner upon selection of the booking offering, and facilitates a transfer of an electronic certificate representative of the offer from the commercial partner to the user.

### CROSS-REFERENCE TO RELATED APPLICATIONS

This patent application is related to and claims the benefit of priority of Australian provisional patent application no. 2022901372 filed on May 23, 2022, the entire contents of which is incorporated by reference.

### FIELD OF THE INVENTION

Embodiments relate to systems and methods for booking a resource via a computerized network.

### BACKGROUND OF THE INVENTION

Computerized booking engines for known resources are known. Booking engines may be used to book a slot of time at a golf course, an appointment with a hairdresser or an apartment for a holiday. Commercial operators of unrelated third-party businesses may wish to engage with the people or users that seek to make a booking with a particular business. Current computerized booking engines are unable to facilitate such an engagement between a user and a third-party business (hereafter “commercial operator”). It is an object of the invention to overcome this and other limitations of prior art booking systems.

### SUMMARY OF THE INVENTION

Embodiments relate to systems and methods for booking a resource. A resource is an event, an affair, or an occasion. For instance, a resource can be a golf game at a golf course, a therapy session at a therapist, a dinning event at a restaurant, rent time for a piece of equipment or a home, etc. It is contemplated for the system to be used for a unique resource—e.g., a resource that is disjoint in time with respect to it being used, experienced, practiced, patroned, etc. For instance, a golf tee time at a particular golf course can only be used by one person (or group or persons) at a time. Thus, use of the resource at time t is disjoint to other uses at time t. The resource is associated with a resource record. The resource record is a predetermined use, experience, practice, or patronage of the resource—e.g., a tee time on a specific date, a hair appointment at a specific salon and specific hair stylist, etc. The booking of the resource is particular to the resource record and based on an offer by a commercial partner for the resource. For instance, the golf course owner (commercial partner) may want to offer tee times between 1:00 pm and 3:00 pm on a specific date and may further want to incentivize certain users to use the resource within that time range, and thus the commercial partner issues a booking offering(s). The booking offering can be an incentive (e.g., a prize, a discount, a monetary award, a coupon, a voucher, legal tender, etc.) for a user to engage with the resource and associated resource record at a time t. All of this can be done via a computer network that coordinates communications, display of information, and activities between various computer devices via a single platform. A user interested in the booking offering can select it, wherein the system facilitates a transfer of electronic funds from the user to the commercial partner. The system can also facilitate a transfer of an electronic certificate representative of the offer from the commercial partner to the user. The user can use that certificate to use the resource at the booked time—e.g., the certificate can be a voucher or a receipt indicating that the user secured the booking of that resource for that time.

An exemplary embodiment relates to a system for booking a resource. The system can include a processor in communication with memory. The processor can be configured to generate a computerized network including a database, a user device, a commercial partner device, an information manager operating module, and a booking operating module. The memory can have instructions stored thereon that when executed can cause the processor to receive, via the information manager operating module, resource data and resource record data from the database. The instructions can cause the processor to receive, via the information manager operating module, offer data from a commercial partner device via the information manager operating module. The instructions can cause the processor to associate, via the information manager operating module, an offer with a resource and a resource record to generate a booking offering. The instructions can cause the processor to transmit, via the booking operating module, the booking offering to the user device. The instructions can cause the processor to display, via the booking operating module, on a user interface of the user device the resource, the resource record, the offer, and the booking offering. The instructions can cause the processor to receive at the information manager operating module, via the booking operating module, a selection of the booking offering. The instructions can cause the processor to facilitate, via the information manager operating module, a transfer of electronic funds from a user to the commercial partner upon selection of the booking offering. The instructions can cause the processor to facilitate, via the information manager operating module, a transfer of an electronic certificate representative of the offer from the commercial partner to the user.

In some embodiments, the processor can be part of or in communication with a server.

In some embodiments, the computerized network can include one or more databases, one or more user devices, one or more commercial partner devices, one or more information manager operating modules, and one or more booking operating modules.

In some embodiments, the resource data can include one or more resources and one or more recourse records. The offer data can include one or more offers. The information manager operating module can generate one or more booking offerings.

In some embodiments, the information manager operating module can associate one or more offers with one or more resources and one or more resource records.

In some embodiments, the resource can be an event, an affair, or an occasion.

In some embodiments, the resource can be a unique resource in that the resource is an event, an affair, or an occasion that is disjoint in time t with respect to the resource being used, experienced, practiced, or patroned.

In some embodiments, the resource record can be a predetermined use, experience, practice, or patronage of the resource.

In some embodiments, the offer can be the resource record at a predetermined time t.

In some embodiments, the booking offering can be an incentive for a user to engage with the resource and associated resource record at a time t.

In some embodiments, the incentive can be a prize, a discount, a monetary award, a coupon, a voucher, or legal tender.

In some embodiments, the transfer of funds from the user to the commercial partner can be based on a price the commercial partner charges to engage with the resource and associated resource record at the time t.

In some embodiments, the price charged by the commercial partner and the incentive of the booking offering can be determined based on a price discrimination tactic and/or a price elasticity tactic.

An exemplary embodiment relates to a method for booking a resource. The method can involve receiving resource data and resource record data. The method can involve receiving offer data. The method can involve associating an offer with a resource and a resource record to generate a booking offering. The method can involve transmitting the booking offering. The method can involve presenting the resource, the resource record, the offer, and the booking offering. The method can involve receiving a selection of the booking offering. The method can involve facilitating a transfer of electronic funds from a user to a commercial partner upon selection of the booking offering. The method can involve facilitating a transfer of an electronic certificate representative of the offer from the commercial partner to the user.

In some embodiments, the resource can be an event, an affair, or an occasion.

In some embodiments, the resource can be a unique resource in that the resource is an event, an affair, or an occasion that is disjoint in time t with respect to the resource being used, experienced, practiced, or patroned.

In some embodiments, the resource record can be a predetermined use, experience, practice, or patronage of the resource.

In some embodiments, the offer can be the resource record at a predetermined time t.

In some embodiments, the booking offering can be an incentive for a user to engage with the resource and associated resource record at a time t.

In some embodiments, the incentive can be a prize, a discount, a monetary award, a coupon, a voucher, or legal tender.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1A is an exemplary computer network architecture for an embodiment of the system;

FIG. 1B is an exemplary system diagram of the operator of the booking engine according to a first aspect of the invention, illustrating an exemplary interaction between commercial partners, users, and unique resources;

FIG. 2 is a schematic of an exemplary unique resource record maintained in the database of the operator of the booking engine of FIG. 1;

FIG. 3 depicts the components of an exemplary unique resource record;

FIG. 4 depicts exemplary steps in an embodiment of the inventive method of the present invention being a second aspect of the invention performed using the booking engine of the first aspect of the invention;

FIG. 5 depicts further steps in the exemplary method of FIG. 3;

FIG. 6 depicts further steps in the exemplary method of FIG. 3;

FIG. 7 depicts exemplary types of offers from commercial partners;

FIG. 8 depicts an exemplary home screen for a venue associated with a unique resource, in this case, a golfing green;

FIG. 9 shows an exemplary initial view of a booking engine's operator's website (or app) according to the first and second aspect of the invention;

FIG. 10 shows exemplary available unique resources (a golf course on a data at a time) available for booking, wherein a user is booking three players into the 8:12 am slot at the particular golf course;

FIG. 11 depicts the ability of the user to select alternate offerings of the unique resource;

FIG. 12 depicts an exemplary operators interface for receiving information about the users and/or those that wanted to book the golf course (the players);

FIG. 13 depicts an exemplary payment interface for non-members who need to pay a few for the unique resource at the time of booking;

FIG. 14 depicts an exemplary confirmation screen for the booking and directs the user back to the booking screen to reveal if the user has won anything from the commercial partner;

FIG. 15 depicts the booked unique resource records and triggers to reveal whether the user has won any prize;

FIG. 16 depicts the four bookings at 8:04 am has not resulted in the user winning a prize;

FIG. 17 depicts an SMS text message received by players who registered using the booking engine;

FIG. 18 depicts an exemplary web page in which the user is asked to engage in a game or activity;

FIG. 19 depicts the questions asked in a quiz to the user of the booking engine, about their interaction with the unique resource; and

FIG. 20 depicts an exemplary resulting screen which shows whether the user has won any prize or is made any further offers to engage.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

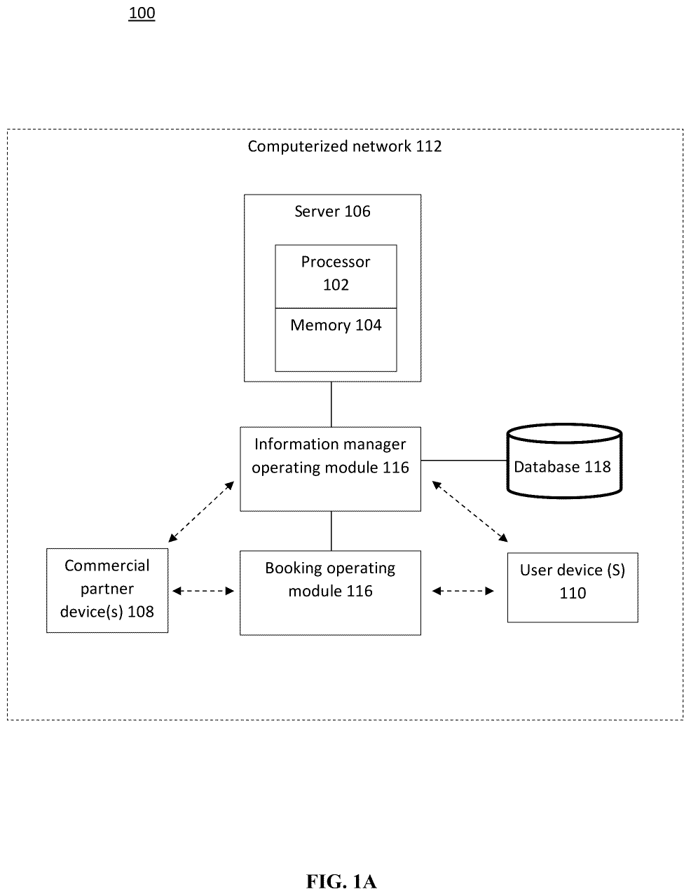

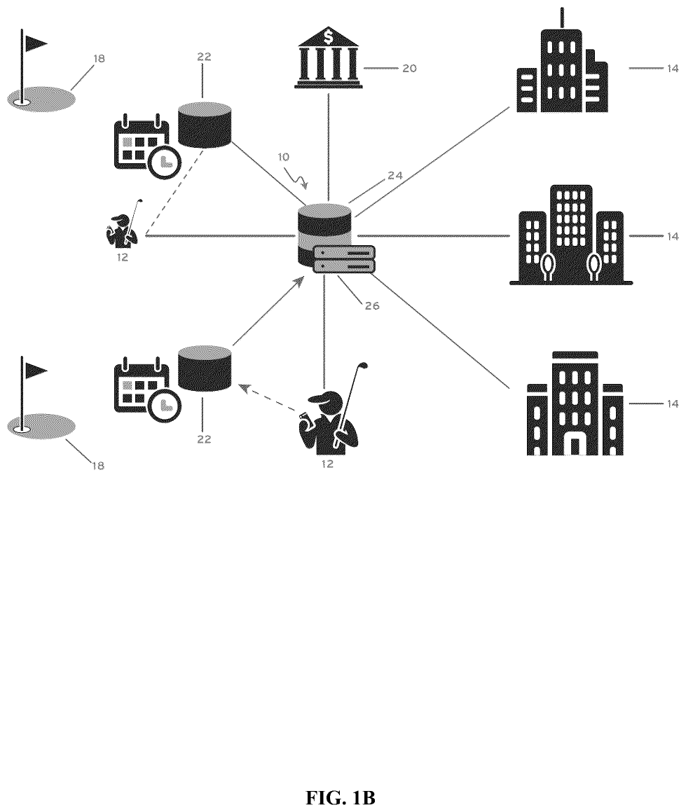

Referring to FIG. 1A, embodiments can relate to a system 100 for booking a resource. The system 100 can include a processor 102 in communication with memory 104. The processor 102 can be part of or in communication with a server 106. The server 106 can be a central component of the system 100 that coordinates most, if not all, communications and activities. Thus, the system 100 can be a centralized network. However, the system 100 can be a distributed network or a hybrid centralized-distributed network.

Any of the processors disclosed herein can be part of or in communication with a machine (e.g., a computer device, a logic device, a circuit, an operating module (hardware, software, and/or firmware), etc.). The processor can be hardware (e.g., processor, integrated circuit, central processing unit, microprocessor, core processor, computer device, etc.), firmware, software, etc. configured to perform operations by execution of instructions embodied in computer program code, algorithms, program logic, control, logic, data processing program logic, artificial intelligence programming, machine learning programming, artificial neural network programming, automated reasoning programming, etc. The processor can receive, process, and/or store data related to resource data, resource record data, offer data, etc. for example.

Any of the processors disclosed herein can be a scalable processor, a parallelizable processor, a multi-thread processing processor, etc. The processor can be a computer in which the processing power is selected as a function of anticipated network traffic (e.g., data flow). The processor can include any integrated circuit or other electronic device (or collection of devices) capable of performing an operation on at least one instruction, which can include a Reduced Instruction Set Core (RISC) processor, a Complex Instruction Set Computer (CISC) microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Any of the processors can be in communication with other processors of other devices (e.g., a computer device, a computer system, a laptop computer, a desktop computer, etc.). For instance, the processor of the server 106 can be in communication with the processor(s) of the commercial partner device 108 and/or the user device 110, the processor of the user device 110 can be in communication with the processor of the commercial partner device 108, etc. Any of the processors can have transceivers or other communication devices/circuitry to facilitate transmission and reception of wireless signals. Any of the processors can include an Application Programming Interface (API) as a software intermediary that allows two or more applications to talk to each other. Use of an API can allow software of any of the processors of the system 100 to communicate with software of a processor of other device(s) outside or the system 100.

It is understood that any transfer of data between devices/memory of the system 100 or between device(s)/memory(ies) within the system 100 and outside of the system 100 can be a pull and/or push operation. For instance, any of the devices/processors/memory can be configured to pull data from another device/processor/memory and/or the other device/processor/memory can be configured to push data thereto. The trigger for the push and/or pull operation can be set via rules established by algorithms, program logic, etc.

The processor 102 can be configured to generate a computerized network 112. The computerized network 112 can include one or more database(s) 114 (each one being an organized collection of structured information or data stored in memory or a data store). The database 114 can retain information about a resource and/or a resource record. This can be in the form of resource data and/or resource record data. The resource data and/or resource record data is provided to the database 114 by a commercial patterner(s) (e.g., a commercial partner device 108).

The computerized network 112 can include a user device 110 (which can include a processor and memory and can be hardware, firmware, software, or a combination thereof). The user can be an individual, a company, a non-profit, a charity, a government agency, etc. that is a customer or consumer or potential customer or potential consumer of the resource. The user device 110 can be configured to generate a user interface (UI) facilitating display of information, interactive control of aspects of the system 100, and allow a user to view and select booking offerings, provide financial data to facilitate transfer of funds (e.g., cash or equivalents) to a commercial partner, etc. The UI can be generated by the server 106 or the user device 110, but it is displayed on the user device 110. The UI can have interactive elements (e.g., interactive GUIs) to facilitate user interaction and control.

The computerized network 112 can include a commercial partner device (which can include a processor and memory and can be hardware, firmware, software, or a combination thereof). The commercial partner can be an individual, a company, non-profit, a charity, a government agency, etc. that is a source of the goods/services associated with the resource. The commercial partner device 108 can be configured to generate a UI facilitating display of information, interactive control of aspects of the system 100, and allow a commercial partner to generate booking offerings, generate electronic certificates representative of offers, etc. The UI can be generated by the server 106 or the commercial partner device 108, but it is displayed on the commercial partner device 108. The UI can have interactive elements (e.g., interactive GUIs) to facilitate commercial partner interaction and control.

The computerized network 112 can include an information manager operating module 116 (which can include a processor and memory and can be hardware, firmware, software, or a combination thereof). While it is contemplated for the information manager operating module 116 to be part of the server 106, it can be a stand-alone module. The information manager operating module 116 receives, transmits, stores, processes, analyzes, coalesces, packets, etc. data based on offers, booking offerings, selections of booking offerings, etc. In an exemplary embodiment, the information operating module 116 is the communication and information dissemination component for all of the other devices (server 106, database 118, commercial partner device 108, user device 110, and booking operating module 116). However, it is understood that other schemes can be used—e.g., the information operating module 116 can be the communication and information dissemination component for only some of the other devices. The information manager operating module 116 can also a transfer of electronic funds and transfer of electronic certificates representative of offers. This can be achieved via a funds transfer engine and/or a payment processing engine, which can be configured to communicate with processing servers of financial institution systems, virtual accounting systems, etc. so as to coordinate transfers such as Automatic Clearing House (ACH) transfers, cryptocurrency transfers, etc.

The computerized network 112 can include a booking operating module 118 (which can include a processor and memory and can be hardware, firmware, software, or a combination thereof). While it is contemplated for the booking operating module 118 to be part of the server 106, it can be a stand-alone module. The booking operating module 118 receives, transmits, stores, processes, analyzes, coalesces, packets, etc. data based on resources, resource records, and offers. The booking operating module generates booking offerings at the directive of commercial partners. For instance, when a commercial partner wants to provide an offer for a resource and associated resource record, the booking operating module 118 receives offer data from the commercial partner device 108. This offer data is paired with the resource and resource record obtained from the database 114 to generate a booking offering. The association of a data structure with another data structure (e.g., association of offer data with resource data, etc.) can be achieved via tagging of metadata, header files, etc.

The memory 104 can have instructions stored thereon that when executed can causes the processor 102 to receive resource data and resource record data from the database 114. These data can be received can be received via the information manager operating module 116. For instance, when setting up the booking offerings, a commercial partner device 108 will transmit a signal to the processor 102 to indicate that the commercial partner wants to provide an offer. The signal can include offer data, which can identify the resource and the resource record. Alternatively, the offer data can be received by the information manager operating module 116 after the processor 102 receives the signal that the commercial partner wants to provide an offer for a resource—in this scenario the signal does not include the offer data. In any event, the information manager operating module 116 can use this offer data information to search the database 114 for the resource and resource record. The information manager operating module 116 can then associate the offer with a resource and a resource record to generate a booking offering.

The generation of the booking offering is via the booking operating module 118. The processor 102 can transmit the booking offering to a user device(s) 110, which can be displayed on the user device 110 via a user interface. The transmission of the booking offering can be achieved via the booking operating module 118. It is contemplated for the booking offering to be transmitted to one or more user devices 110. The determination as to which user device 110 receives particular boking offering can depend on pricing and marketing strategies. For instance, a commercial partner may only want to send booking offerings to a certain number of users, to a certain classification of users, etc. In addition, the commercial partner may want to send certain users a first type of booking offering while sending other users a second type of booking offering—e.g., the commercial partner can engage in price discrimination. Information specific to this discriminatory offering can be embedded in the offer data. The booking operating module 118 and/or the information manager operating module 116 can then generate and transmit booking offerings to user devices 110 based on the commercial partner's desired price discrimination and marketing tactics. Information about the user and user device 110 to enable such discriminatory tactics can be obtained from user profiles (when a user signs up for an account for using the system), other user data obtained from other sources (e.g., social media platforms, e-commerce marketing platforms, etc.), etc. Users, when setting up an account with the system 100, can provide the system 100 with personal information such as name, age, demographic information, financial account information, etc. This can be referred to as user profile information. Commercial partners also create an account and provide similar commercial partner profile information.

As noted above, the booking operating module 118 can display the booking offering on the user device 110 via a user interface. The booking operating module 118 can also display the resource, the resource record, and/or the offer, along with the booking offering. The purpose of displaying the resource, resource record, and/or offer is to allow a user to quickly digest the information about the booking offering. The display of information can be textual, graphical, etc. The user interface can include actuable elements (e.g., GUIs), allowing a user to make selections, enter inputs, tailor displays, conduct searches for resources, conduct searches for resource records, etc. A similar user interface can be generated for the commercial partner devices 108. The user interface for the commercial partner device 108 can be further configured to provide statistical information about the resource, resource record, user, etc. For instance, the user interface for the commercial partner device 108 can provide information regarding how many users viewed the booking offerings, how many times the user instantiated a session in which the booking offering was displayed, how many times users search for the resource or resource record, etc.

Upon selection of a booking offering by a user of a user device 110, the information manager operating module 116 receives the selection in the form of a signal from the booking operating module 118—a signal indicating that a user via a user device 110 selected the booking offering. If the resource is a unique resource, once a selection is made, the booking offering is either deleted or the system 100 otherwise indicates it as non-available to other users—e.g., the display on other user devices 110 shows that particular booking offering as not available, removes that booking offering from their displays, prevents that booking offering from being displayed, etc.

The booking offering is a contractual agreement—there is an offer and an acceptance with an associated consideration for the transaction. Thus, upon selection of the booking offering by a user, the system 100 automatically transfers funds in accordance with the offering. For instance, the information manager operating module 116 can transfer of electronic funds from a user (using the user's financial account on file via the user profile) to the commercial partner (using the commercial partner's financial account on file via the profile) upon selection of the booking offering. The information manager operating module 116 can also transfer an electronic certificate representative of the offer from the commercial partner to the user (e.g., transfer an electronic certificate to the user device 110 that is a voucher, receipt, etc. that the user can present when it is time to use the resource).

The system 100 can be a robust system in that it can include one or more databases 114, one or more user devices 110, one or more commercial partner devices 108, one or more information manager operating modules 116, and/or one or more booking operating modules 118. Furthermore, the system 100 can provide one or more resources (including one or more types of resources), provide one or more recourse records (including one or more types of resource records), provide one or more offers (including one or more types of offers), one or more booking offerings (including one or more types of booking offerings), etc. The one or more offerings and/or one or more booking offerings can be for one or more resources or one or more resource records—e.g., there can be more than one offering or type of offering for each resource or resource record. For instance, the information manager operating module 116 can associate one or more offers with one or more resources and/or one or more resource records.

As noted herein, the resource can be one or more events, affairs, occasions, etc. The resource can be a unique resource in that the resource is an event, an affair, and/or an occasion that is disjoint in time t with respect to the resource being used, experienced, practiced, or patroned. The resource record can be a predetermined use, experience, practice, or patronage of the resource. The offer can be the resource record at a predetermined time t. The booking offering can be an incentive for a user to engage with the resource and associated resource record at a time t. The incentive can be a prize, a discount, a monetary award, a coupon, a voucher, legal tender, result of a wager, a donation, chance to win or receive a prize, etc. The transfer of funds from the user to the commercial partner can be based on a price the commercial partner charges to engage with the resource and associated resource record at the time t. With this in mind, and as alluded to before, the price charged by the commercial partner and the incentive of the booking offering can be determined based on a price discrimination tactic and/or a price elasticity tactic.

As can be appreciated from the above disclosure, embodiments can be related to a method for booking a resource. The method can involve receiving resource data and resource record data. The method can involve receiving offer data. The method can involve associating an offer with a resource and a resource record to generate a booking offering. The method can involve transmitting the booking offering. The method can involve presenting the resource, the resource record, the offer, and the booking offering. The method can involve receiving a selection of the booking offering. The method can involve facilitating a transfer of electronic funds from a user to a commercial partner upon selection of the booking offering. The method can involve facilitating a transfer of an electronic certificate representative of the offer from the commercial partner to the user.

In some embodiments, the information manager operating module 116 can transmit communications (e.g., SMS texts, emails, textual alerts on user interfaces, etc.) to user devices 110 and/or commercial partner devices 108 to inform them of certain activities, when bookings are confirmed, when payment is received, alerts, reminders, etc.

In some embodiments, the information manager operating module 116 can generate questionnaires to be displayed on user interfaces of user devices 110 and/or commercial partner devices 108. The questionnaires can be used for generating marketing data, customer satisfaction data, etc. Results of the questionnaires can be used be the entity administering the system 100, sent to commercial partners, etc.

### Examples

The following are exemplars of how the inventive method and system can be implemented.

As can be appreciated from the disclosure above, aspects of the disclosure can relate to a wagering and gamified booking engine, wherein the booking engine comprises: a database of records representing unique resources; a server for communicating over a computerised network with: a) users who wish to select one or more unique resources; b) commercial partners who wish to engage with users; c) an information manager for: i) associating an offer from the commercial partner with one or more records of unique resources; ii) making the unique resources available for selection to users; iii) providing the Offer to the user from the commercial partner associated with the record of unique resource or resources.

Preferably the information manager is adapted to receive electronic payment information from the user in consideration for the use or temporary hire or time with the unique resource. Still more preferably the Offer made to the user is one of: a wager; a prize; a target score in the case of booked games and sporting matches; games.

Preferably, the offer is a chance to receive a cash prize or equivalent and where the commercial partner directs the operator of the booking engine, via the information manager, to provide certain odds or payout rates across the unique resource records associated with offers.

More preferably the identification of the commercial partner is displayed on the unique resource record prior to the user selecting the desired unique resources.

Still more preferably, after selecting the desired unique resource or resources, the information manager reveals to the user whether they qualify for the prize or cash money or if they are able to play a game or make a wager.

Thereafter the information manager is adapted to communicate with the commercial partner to indicate the user or users who have been provided the offer and those that have qualified or accepted the offer.

A unique resource is anything that can't be enjoyed by two persons at the same time and that must be booked by the user to engage with it. For example, each available slot at a golf course would be a unique resource. Whilst the course can be enjoyed by many people, the starting slots are limited to a certain number per day and the days are unique so that any given time(slot) and date and course represents an opportunity to book in to play golf at that time and place which is regarded as a unique resource. Similarly booking a hairdresser or holiday rental is much the same. Only one person can book them at any given time and they can't be cloned to service more than one person at a time. Although the invention has application outside the field of booking golf tee times, the invention will be principally discussed in this context via these examples.

Referring to FIG. 1 there is a schematic for the booking engine 10 and the manner in which it interacts with a plurality of users 12, commercial partners 14 and unique resources 16, bank 20 and unique resource information managers 22 which all communicate with the booking engine 10 over a computerised network, preferably, the Internet. Booking engine 10 is comprised of database 24 and server 26. It also comprises an information or application manager (not shown).

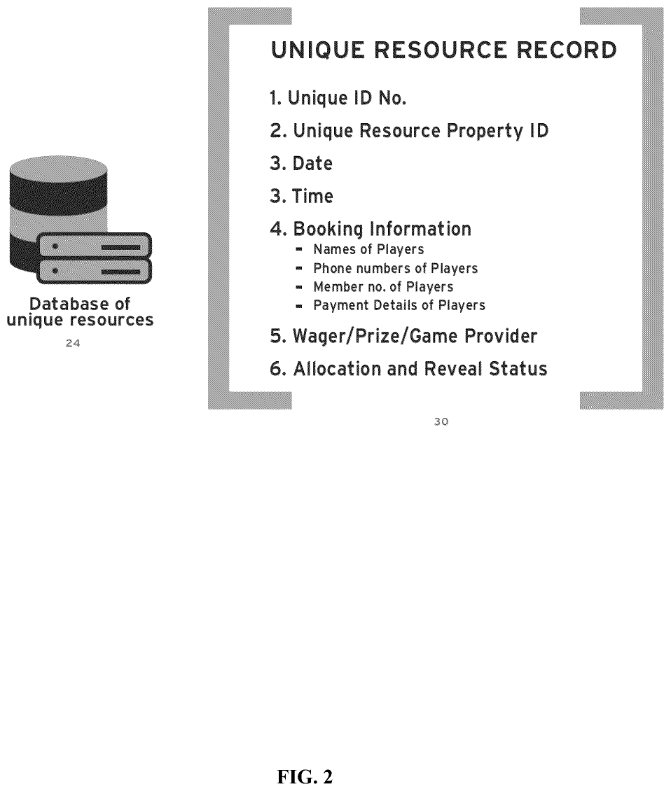

Database 24 maintains entries it within its datastore. These are best shown in FIGS. 2 and 21. Database 24 is comprised of a vast plurality of unique resource records (URR) 30 which in turn are comprised of various fields in the record including fields that detail or describe the unique resource 32 derived from the unique resources information managers 22. There are also fields that are associated with the offer 34 and fields associated with the user's interaction with the offer 36. Information in fields 34 is obtained from the commercial partners information systems 14 and the information in fields 36 is created by the operator's information manager (not shown) which creates and populates the fields depending on the interactions the user has had with the offer presented to them.

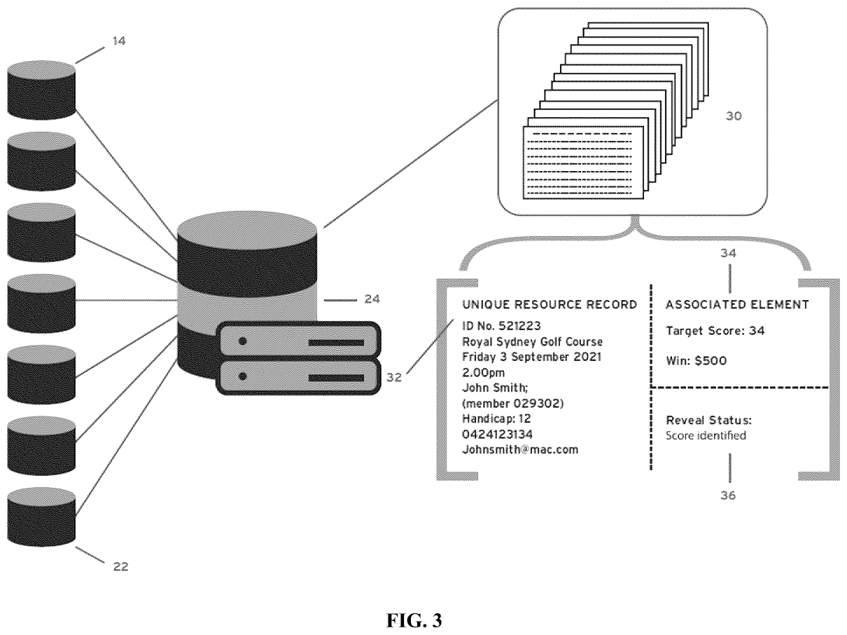

FIGS. 3 to 5 depicts steps in a method comprising a second aspect of the invention. FIG. 3 depicts the process of a commercial partner obtaining allocated unique resource records. The first step in the method if step 40 with the commercial partner's information management system 14 contacting the information manager of engine 10 and obtaining purchase credits for unique resources. Once the credits have been credited against the account of the commercial partner the commercial partner formulates its offers and passes them to the information manager of the engine 10 in step 42. In step 46 the commercial partner 14 chooses what URR 30 records the offers are to be allocated. In Step 46 the operator of engine 10 executes the offer in connection with a user who has selected the unique resource.

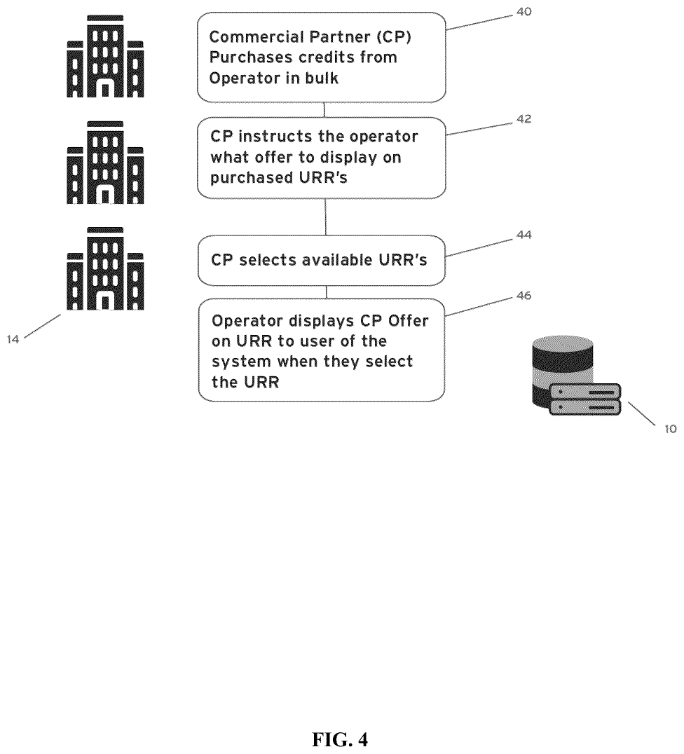

FIG. 4 depicts the process by which the commercial partner 14 chooses available URR 30. In the method depicted, step 50 comprises the step of the commercial partner 14 selecting available URRs 30. This can be achieved by the information manager of engine 10 providing the commercial partners 14 with lists of available URR 30 in step 52. The commercial partner 14 is able to choose URR's based on any of the recorded information stored in respect of the unique resource, including for a golf course, the course, time and date. In this way, commercial partners 14 can hone in on the resources they wish to piggy back in order to have an engagement with a user selecting that unique resource.

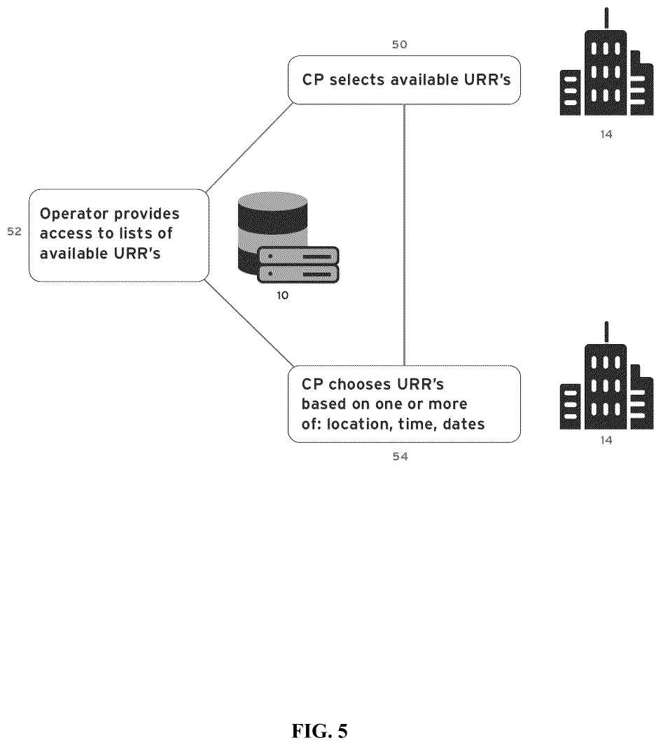

FIG. 5 depicts the user's experience post allocation of the URR 30 to the commercial partner 14 in the final step of the method. The method is commenced by the user 12 visiting the unique resource information management system 22 of the unique resource 18. The unique resource information management system 22 is adapted to deliver the user 12 to the booking engine 10 in step 62. Booking engine 10 displays to the user 12 the timeslots the unique resource can be booked and those that are available in step 64. The user 12 makes a selection in step 66. The operator of engine 10 then executes or displays the offer from the commercial partner in step 68. The user interacts with the offer 70 without leaving the engine 10.

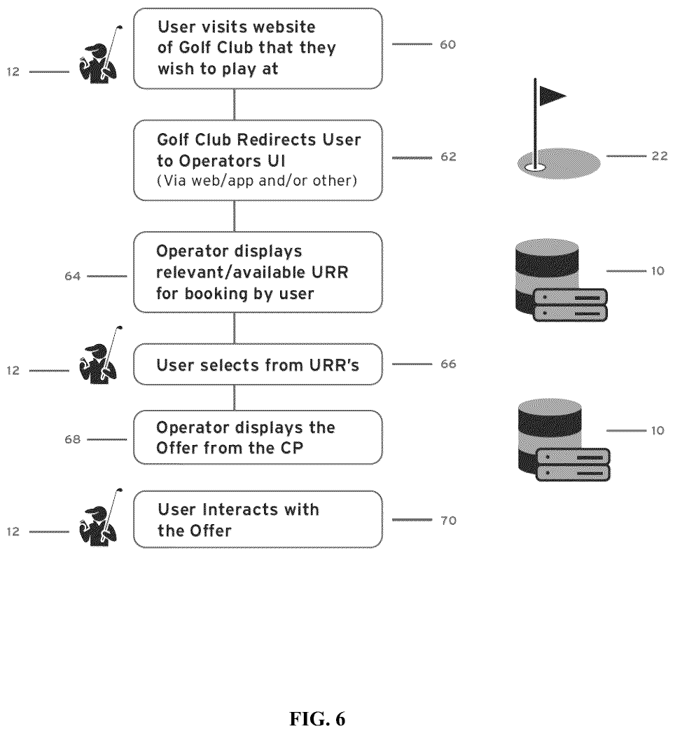

Referring to FIG. 6, although the term “offer” has been used in respect of that which the commercial partner 14 wishes to make available to the user for engagement, the term is more encompassing than its natural and ordinary meaning. In the present context, the commercial partner offer is intended to include the provision of:
Instant Prizes including those revealed on selection of the unique resource by the user at the time of booking;
Odds for wagers—including wagers where the making of the bet is the act of selecting of the unique resource by the user at the time of booking;
Target Scores—for where the booked resource adapts or facilitates the playing of a game with scores, the user is offered a score which if bettered, would result in the provision of cash or other prize including club credit, of the sort described in U.S. Pat. No. 10,413,801B2, the contents of which are incorporated by way of reference; and
Games.

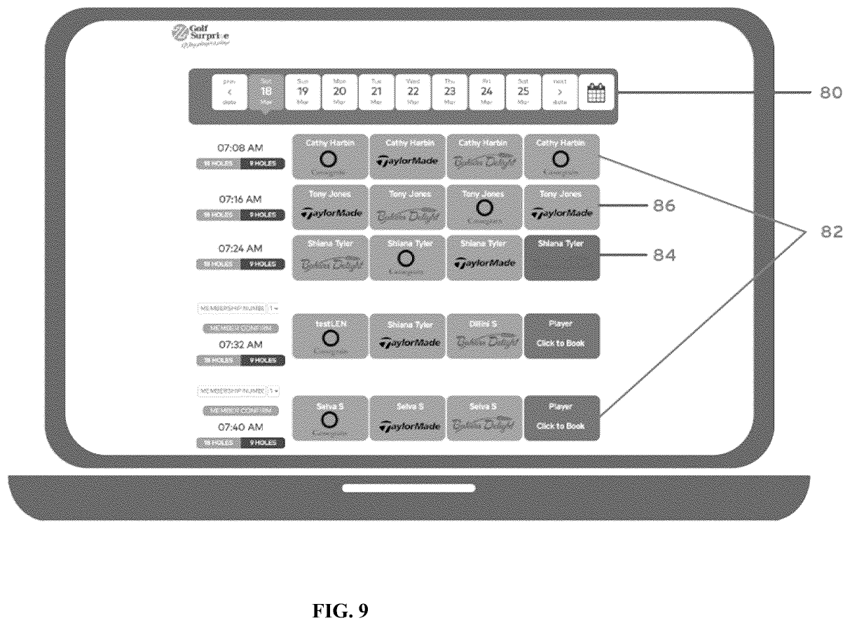

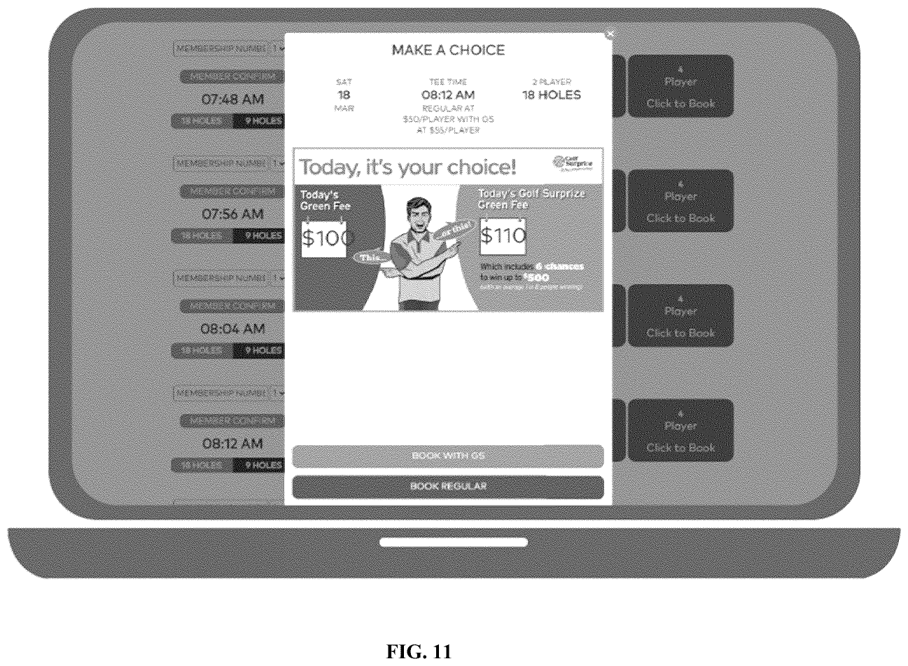

For example, a commercial partner may wish to offer users of particular unique resources the chance to win a prize (as exemplified in FIGS. 9 to 16). In such a case the commercial partner's system 14 communicates with engine 10 to purchase, for example, 1000 URR 30. Then the commercial partners system communicates with engine 10 to allocate these as potential prizes to URR it selects out of the many more available URR 30. It indicates to the engine 10 what ratio of winning to non-winning to implement over the selected URR's as well as the quantum of the prizes to be offered. Preferably the ratio is between 1:1 (everyone is a winner) to 1:8 where 1 in 8 URR's holds a winning prize. Having said this, if a commercial partner is allocated 500 URR the ratio of winning to losing URR's could be 1:499. In such cases where the odds are much more likely to result in a non-winning outcome, the prize can be made larger to generate more excitement despite the lower chance of winning.

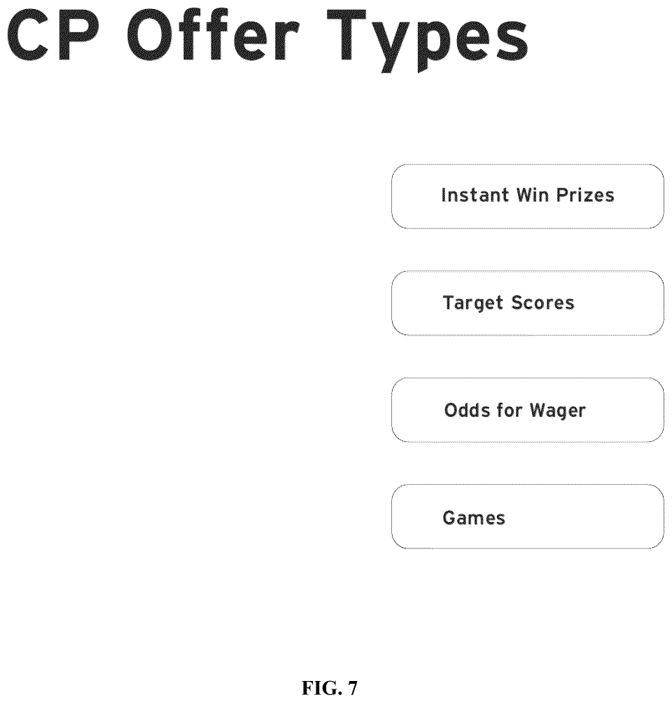

FIGS. 7 to 16 depict various points in the method set out in FIG. 5 in the context of a golf course tee time booking engine. FIG. 7 shows the golf course's website and the option of booking a tee time using the “golfsurprize” booking engine. For present purposes Golfsurprize is the computer system or information manager that operates the booking engine 10.

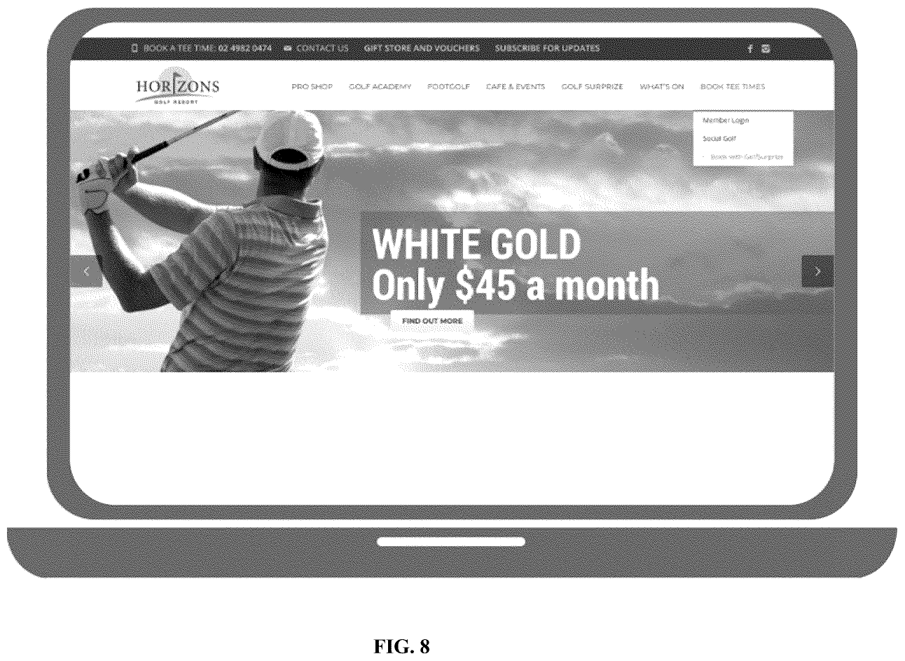

FIG. 8 depicts the landing page for the unique resource being the Horizon's Golf Resort. The interface allows a user to select a date 80 to view tee times 82. In the present embodiment, commercial partners have selected certain time slots on the courses for the date selected and allocated offers to them. In the present case, the offer is instant cash prizes (or equivalent non-cash value in store credit). The user can see that Bakers Delight has provided a prize of $50 to one user who booked the 7:24 am slot on 6 May as depicted in green as a winning tee time 84. Non-winning slots are indicated as booked but not winners (orange slots) 86.

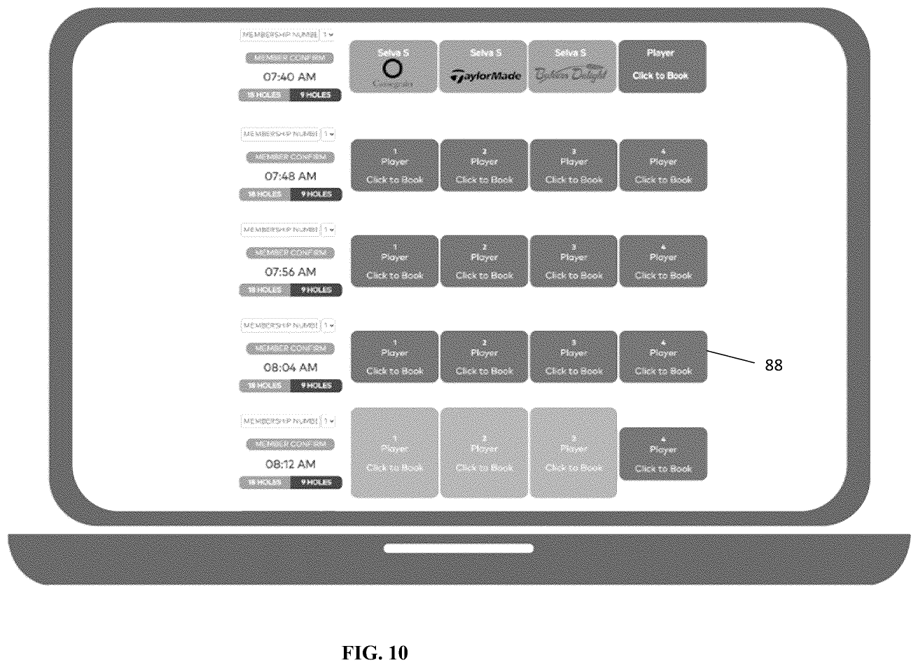

FIG. 9 shows four available slots at 8:04 am at the course on the date selected by the user. The user 12 selects those slots 88 ash shown in FIG. 10. One of the features of engine 10 is that is allows a user to select a unique resource and then offer the user multiple ways of booking the unique resource. This allows the operator of the engine 10 to offer the user 12 the resource at different price points or as inclusions in a larger offering including commercial partners offers. The enlarged offering may include an amount of money to go towards a wager offered by a commercial partner in this pre-purchase step of the method. Or it may involve agreement to consent to the inclusion of the user in some other activity.

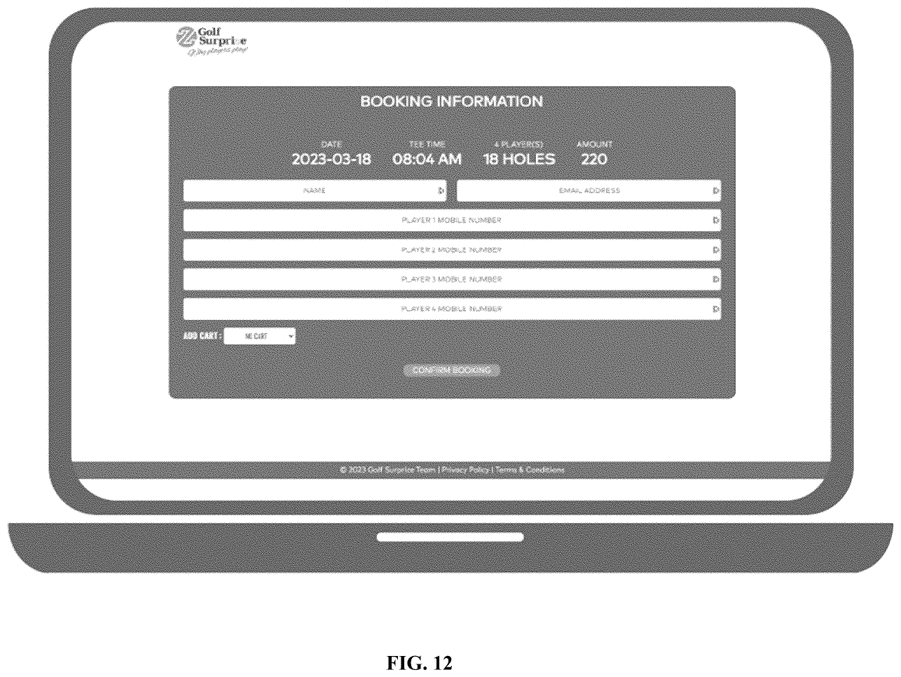

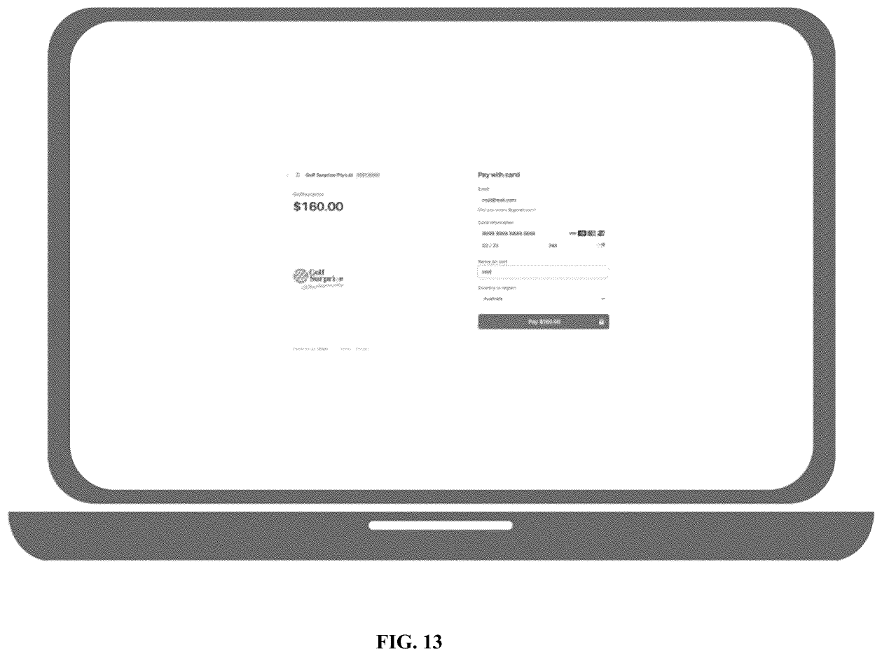

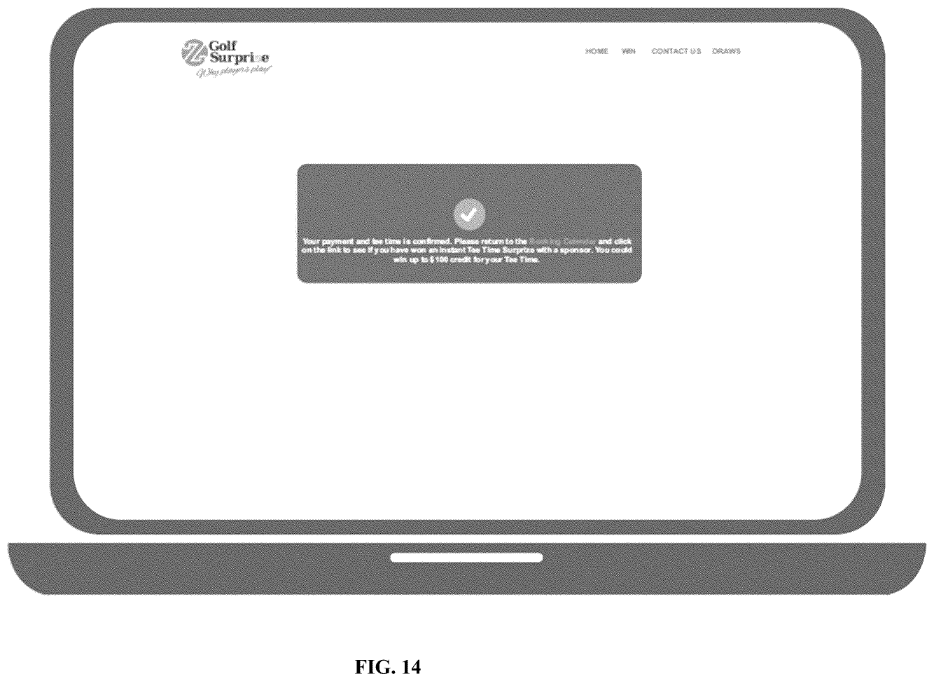

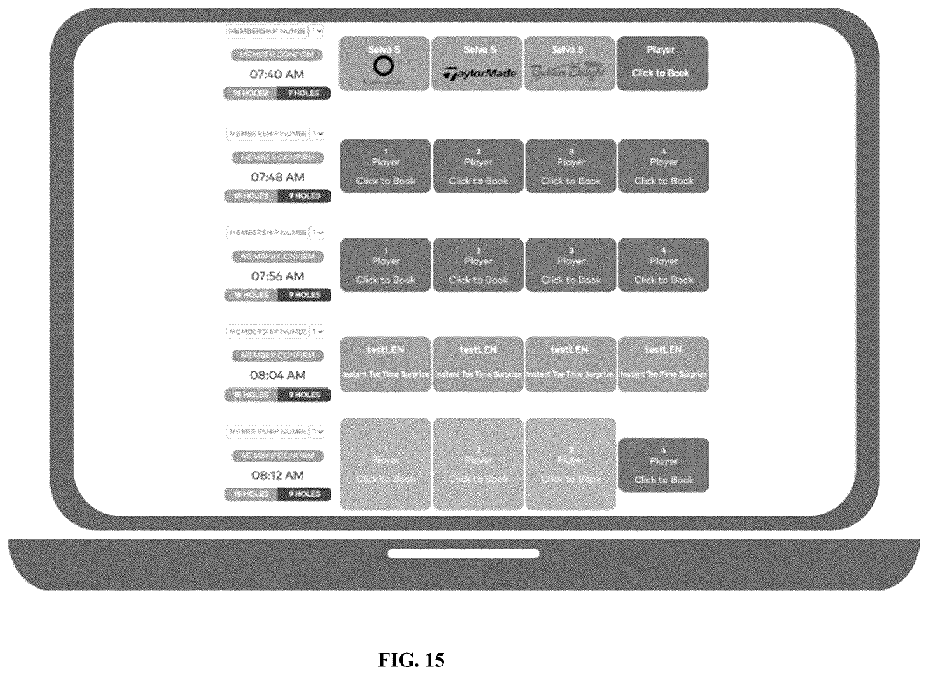

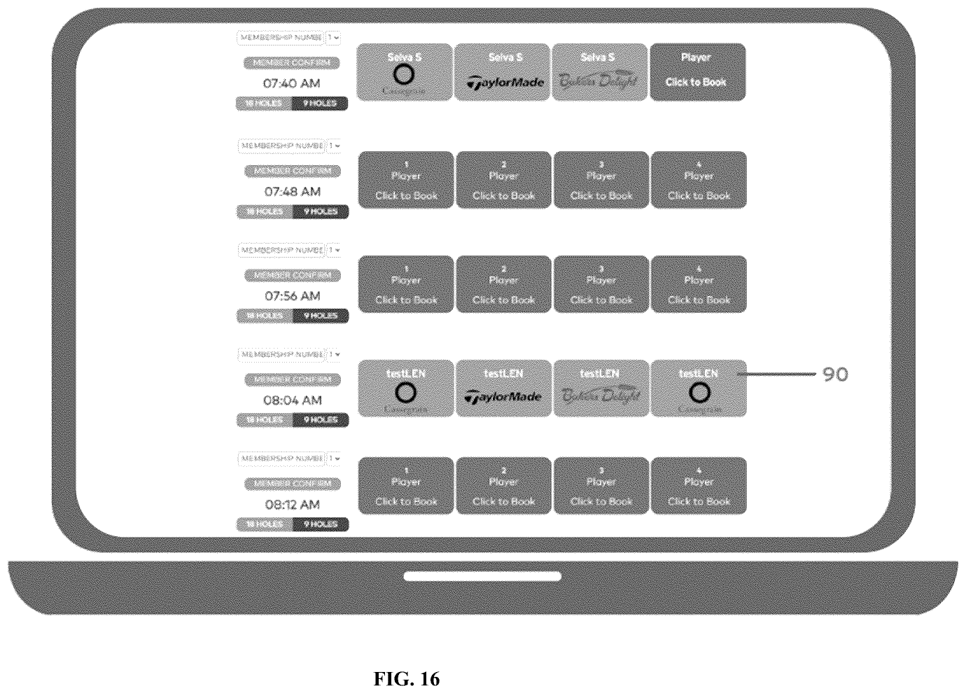

FIG. 12 shows the operator of engine 10 taking the details of the persons who have booked the unique resource 18. FIGS. 13 and 14 show the engine 10 confirming the booking of the unique resource. In FIG. 15, the user is returned to the booking page and notes that they are eligible to now reveal whether the slots that the user booked have prizes associated with them. FIG. 16 depicts the slots 90 showing that the slots were not winning slots. It also reveals the name of the commercial partner on the slot. If there had of been any winning entries the information manager of the engine 10 would communicate with the commercial partner system 14 to inform them of the identity of the winner so that the winner can be provided their prize money or prize.

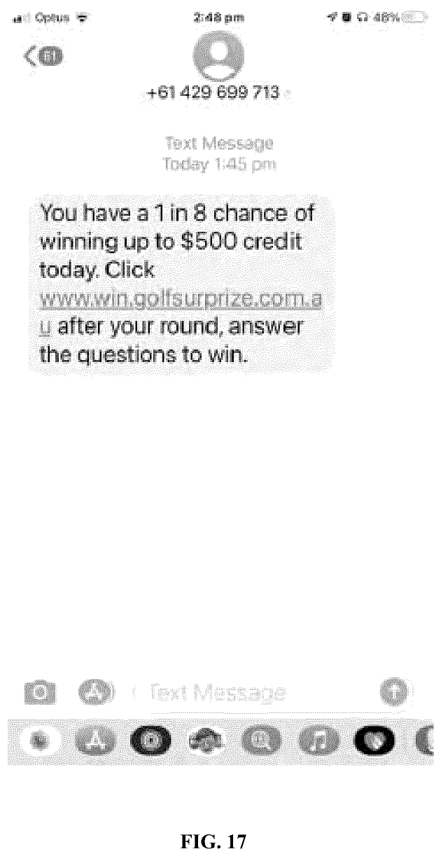

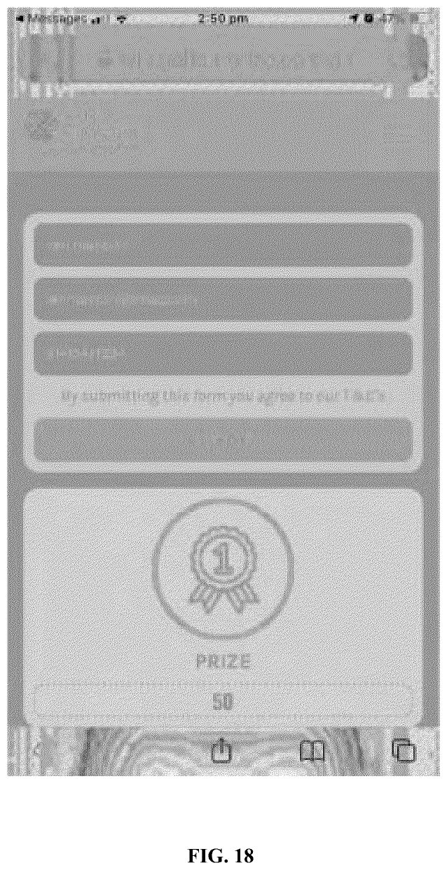

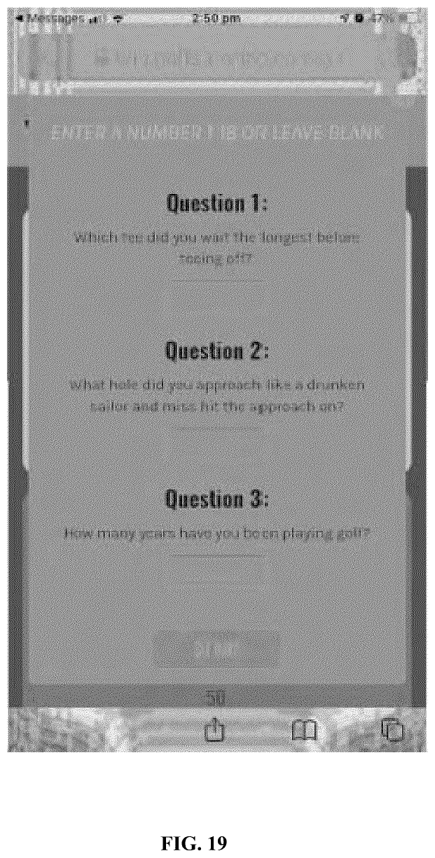

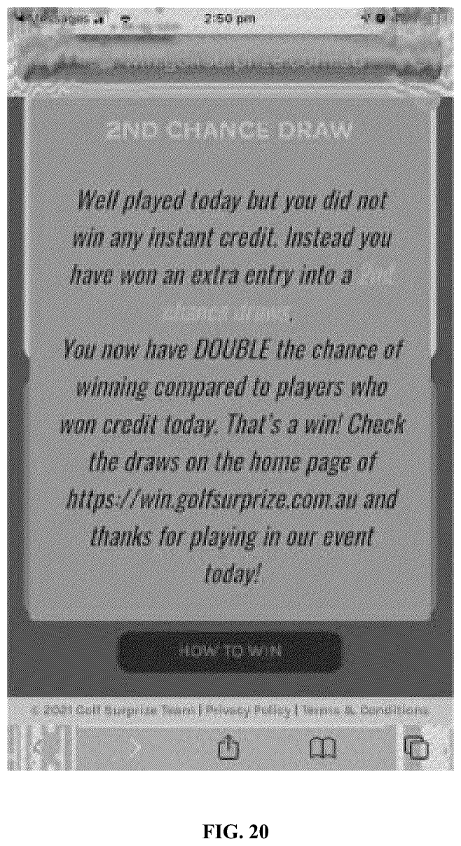

FIGS. 13 to 20 show a various of smartphone screenshots as they would appear on the smartphone of user 12. The smartphone is where a number of offers can be executed under the direction of the information manager of engine 10.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the apparatuses and methods of using and making the same disclosed herein have been discussed and illustrated, it is to be distinctly understood that the invention is not limited thereto but may be otherwise variously embodied and practiced within the scope of the following claims.

What is claimed is:

1. A system for booking a resource, the system comprising:
a processor in communication with memory, the processor configured to generate a computerized network including a database, a user device, a commercial partner device, an information manager operating module, and a booking operating module;
wherein the memory has instructions stored thereon that when executed cause the processor to:
receive, via the information manager operating module, resource data and resource record data from the database;
receive, via the information manager operating module, offer data from a commercial partner device via the information manager operating module;
associate, via the information manager operating module, an offer with a resource and a resource record to generate a booking offering;
transmit, via the booking operating module, the booking offering to the user device;
display, via the booking operating module, on a user interface of the user device the resource, the resource record, the offer, and the booking offering;
receive at the information manager operating module, via the booking operating module, a selection of the booking offering;
facilitate, via the information manager operating module, a transfer of electronic funds from a user to the commercial partner upon selection of the booking offering; and
facilitate, via the information manager operating module, a transfer of an electronic certificate representative of the offer from the commercial partner to the user.

2. The system of claim 1, wherein:
the processor is part of or in communication with a server.

3. The system of claim 1, wherein:
the computerized network includes one or more databases, one or more user devices, one or more commercial partner devices, one or more information manager operating modules, and one or more booking operating modules.

4. The system of claim 1, wherein:
the resource data includes one or more resources and one or more recourse records;
the offer data includes one or more offers;
the information manager operating module generates one or more booking offerings.

5. The system of claim 1, wherein:
the information manager operating module associates one or more offers with one or more resources and one or more resource records.

6. The system of claim 1, wherein:
the resource is an event, an affair, or an occasion.

7. The system of claim 6, wherein:
the resource is a unique resource in that the resource is an event, an affair, or an occasion that is disjoint in time t with respect to the resource being used, experienced, practiced, or patroned.

8. The system of claim 7, wherein:
the resource record is a predetermined use, experience, practice, or patronage of the resource.

9. The system of claim 8, wherein:
the offer is the resource record at a predetermined time t.

10. The system of claim 8, wherein:
the booking offering is an incentive for a user to engage with the resource and associated resource record at a time t.

11. The system of claim 10, wherein:
the incentive is a prize, a discount, a monetary award, a coupon, a voucher, or legal tender.

12. The system of claim 11, wherein:
the transfer of funds from the user to the commercial partner is based on a price the commercial partner charges to engage with the resource and associated resource record at the time t.

13. The system of claim 12, wherein:
the price charged by the commercial partner and the incentive of the booking offering is determined based on a price discrimination tactic and/or a price elasticity tactic.

14. A method for booking a resource, the method comprising:
receiving resource data and resource record data;
receiving offer data;
associating an offer with a resource and a resource record to generate a booking offering;
transmitting the booking offering;
presenting the resource, the resource record, the offer, and the booking offering;
receiving a selection of the booking offering;
facilitating a transfer of electronic funds from a user to a commercial partner upon selection of the booking offering; and
facilitating a transfer of an electronic certificate representative of the offer from the commercial partner to the user.

15. The method of claim 14, wherein:
the resource is an event, an affair, or an occasion.

16. The method of claim 15, wherein:
the resource is a unique resource in that the resource is an event, an affair, or an occasion that is disjoint in time t with respect to the resource being used, experienced, practiced, or patroned.

17. The method of claim 16, wherein:
the resource record is a predetermined use, experience, practice, or patronage of the resource.

18. The method of claim 17, wherein:
the offer is the resource record at a predetermined time t.

19. The method of claim 17, wherein:
the booking offering is an incentive for a user to engage with the resource and associated resource record at a time t.

20. The method of claim 19, wherein:
the incentive is a prize, a discount, a monetary award, a coupon, a voucher, or legal tender.
